(19) United States
(12) Patent Application Publication
(10) Pub. No.: US 2015/0315981 A1
(43) Pub. Date: Nov. 5, 2015

(54) FUEL SUPPLY SYSTEM

(71) Applicant: General Electric Company, Schenectady, NY (US)

(72) Inventors: Carlos Gabriel Roman, Simpsonville, SC (US); Keegan Saunders O'Donnell, Greenville, SC (US)

(73) Assignee: General Electric Company, Schenectady, NY (US)

(21) Appl. No.: 14/268,605

(22) Filed: May 2, 2014

(51) Int. Cl. F02C 9/32; F02C 3/22; F23R 3/28; F02C 9/40

(52) U.S. Cl. CPC F02C 9/32; F02C 9/40; F02C 3/22; F23R 3/286

(57) ABSTRACT

A fuel supply system includes a fuel line path configured to route a fuel to a combustion inlet region. Also included is a flow manipulation member disposed proximate the fuel line path, the flow manipulation member comprising a piezoelectric material configured to cyclically manipulate a mass flow pressure of the fuel being routed through the fuel line path.

### BACKGROUND OF THE INVENTION

The subject matter disclosed herein relates to fuel supply systems and, more particularly, to a fuel supply system configured to route fuel to a combustion assembly of a gas turbine engine.

In a gas turbine engine, air is pressurized in a compressor and mixed with fuel in a combustor for generating hot combustion gases that flow downstream through turbine stages where energy is extracted. Large industrial power generation gas turbine engines typically include a plurality of combustor cans within which combustion gases are separately generated and collectively discharged.

Of particular concern to effective operation of can combustor engines is combustion dynamics (i.e., dynamic instabilities in operation). High dynamics are often caused by fluctuations in conditions such as the temperature of the exhaust gases (i.e., heat release) and oscillating pressure levels within a combustor can. Such high dynamics can limit hardware life and/or system operability of an engine, causing such problems as mechanical and thermal fatigue.

Various attempts to control combustion dynamics have been made in an effort to prevent degradation of system performance. Such efforts include, for example, reducing dynamics by decoupling the pressure and heat release oscillations (e.g., by changing the flame shape, location, etc. to control heat release within a combustion engine) or “de-phasing” the pressure and heat release. A resonator is one component that has been employed to achieve such dynamics reductions. However, increasing power output requirements results in a smaller window of combustion operability since matching of combustion and turbine frequencies is to be avoided.

### BRIEF DESCRIPTION OF THE INVENTION

According to one aspect of the invention, a fuel supply system includes a fuel line path configured to route a fuel to a combustion inlet region. Also included is a flow manipulation member disposed proximate the fuel line path, the flow manipulation member comprising a piezoelectric material configured to cyclically manipulate a mass flow pressure of the fuel being routed through the fuel line path.

According to another aspect of the invention, a fuel supply system includes a fuel line path configured to route a fuel to a combustion inlet region. Also included is a valve located proximate the fuel line path. Further included is a piezoelectric member operatively coupled to the valve and configured to cycle the valve between an open condition and a closed condition to cyclically manipulate a mass flow pressure of the fuel being routed through the fuel line path.

According to yet another aspect of the invention, a gas turbine system includes a compressor, a combustion assembly having at least one combustion chamber, and a turbine section. Also included is a fuel supply system configured to route a fuel to the combustion assembly, the fuel supply system. The fuel supply system includes a fuel line path defined by an inner surface of a wall of a pipe, the fuel line path configured to route a fuel to a combustion inlet region. The fuel supply system also includes a volume formed as a cavity in the wall of the pipe and fluidly coupled to the fuel line path via an orifice. The fuel supply system further includes a flow manipulation member located within the volume and configured to cyclically manipulate a mass flow pressure of the fuel being routed through the fuel line path, wherein the flow manipulation member comprises a piezoelectric material.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a schematic illustration of a fuel supply system for delivering fuel to the gas turbine engine;

FIG. 3 is a plot of mass flow pressure within a portion of fuel line path as a function of time;

FIG. 4 is a schematic illustration of a volume having a flow manipulation member therein according to a first embodiment; and

FIG. 5 is a schematic illustration of a volume having a flow manipulation member therein according to a second embodiment.

The detailed description explains embodiments of the invention, together with advantages and features, by way of example with reference to the drawings.

### DETAILED DESCRIPTION OF THE INVENTION

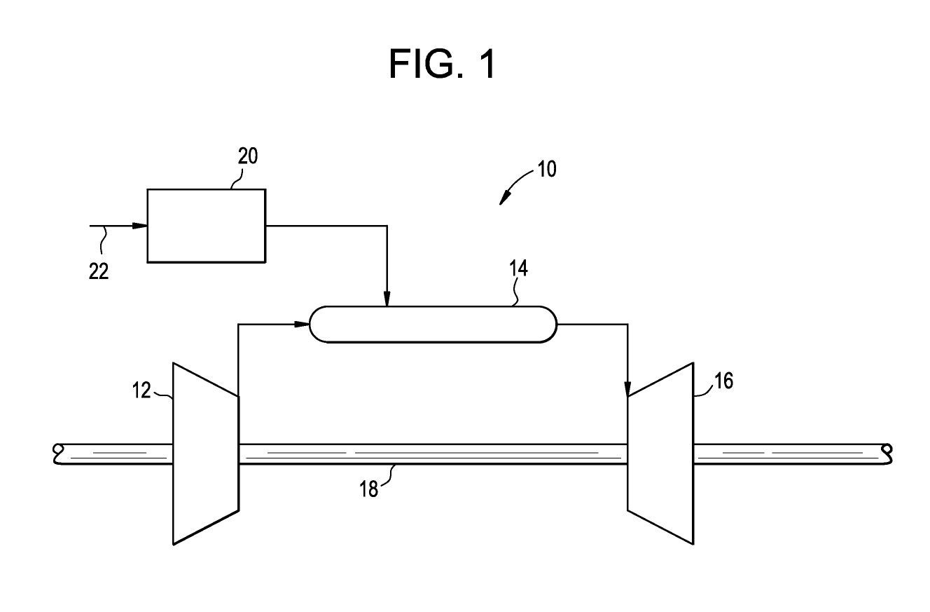

Referring to FIG. 1, a gas turbine engine 10, constructed in accordance with an exemplary embodiment of the invention, is schematically illustrated. The gas turbine engine 10 includes a compressor section 12, a combustion assembly 14, a turbine section 16, a shaft 18 and a fuel supply system 20. It is to be appreciated that one embodiment of the gas turbine engine 10 may include a plurality of compressor sections 12, combustion assemblies 14, turbine sections 16, and/or shafts 18. The compressor section 12 and the turbine section 16 are coupled by the shaft 18. The shaft 18 may be a single shaft or a plurality of shaft segments coupled together to form the shaft 18.

In operation, air flows into the compressor section 12 and is compressed into a high pressure gas. The high pressure gas is supplied to the combustion assembly 14 and mixed with a fuel 22, for example process gas and/or synthetic gas (syngas). Alternatively, the combustion assembly 14 can combust fuels that include, but are not limited to natural gas and/or fuel oil. The fuel/air or combustible mixture is ignited to form a high pressure, high temperature combustion gas stream. Thereafter, the combustion assembly 14 channels the combustion gas stream to the turbine section 16, which converts thermal energy to mechanical, rotational energy.

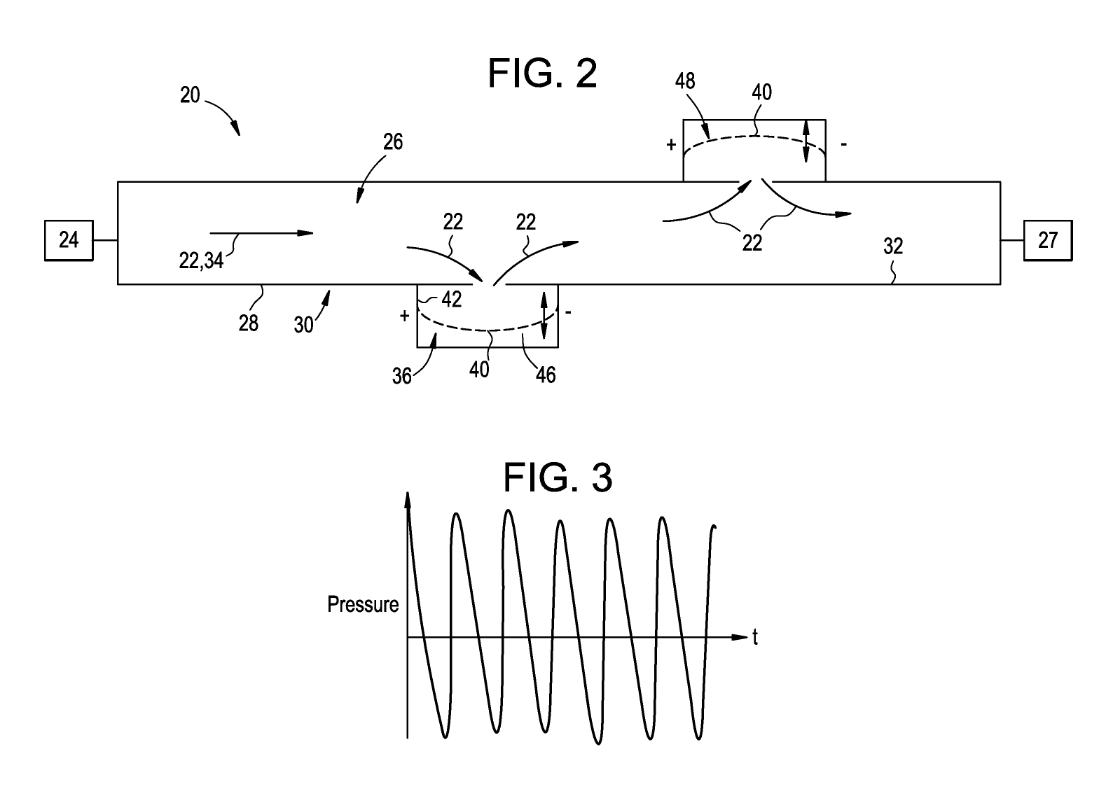

Referring now to FIG. 2, the fuel supply system 20 configured to route the fuel 22 to the combustion assembly 14 is illustrated in greater detail. A fuel source 24, such as a fuel manifold, directs the fuel 22 from a supply (not illustrated) to a fuel line path 26. The fuel line path 26 extends between the fuel source 24 and the combustion assembly 14. In particular, the fuel line path 26 provides a path for the fuel 22 to flow to a combustion inlet region 27 of the combustion assembly 14, such as a plenum and/or fuel injection nozzle. The fuel line path 26 is formed of at least one pipe segment, but typically a plurality of pipe segments are operatively coupled to each other, such as in a welded manner.

As will be appreciated from the description herein, mass flow fluctuations or oscillations are imposed on the fuel 22 being routed within the fuel line path 26 and therefore the combustion assembly 14, advantageously oscillating flow pressure of the combustion assembly 14. Such an assembly reduces or avoids the need for phase-matching avoidance techniques that are otherwise required. As shown in FIG. 3, an exemplary profile of the mass flow pressure of the fuel 22 is illustrated along a portion of the fuel line path 26 as a function of time. The mass flow of the fuel 22 for combustion, as measured within the fuel line path 26 oscillates in a cyclical manner as a function of axial location along a length of the fuel line path 26.

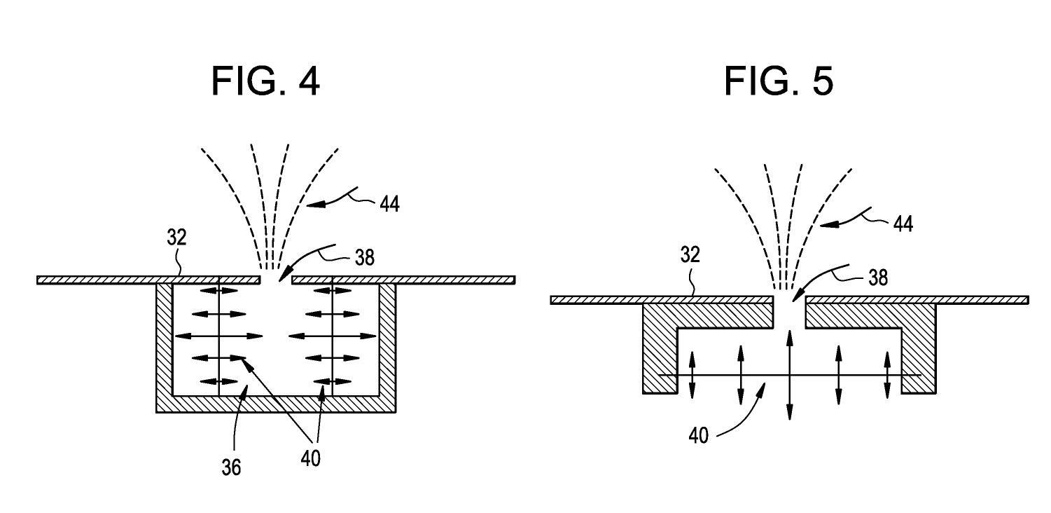

With continued reference to FIG. 2, the fuel line path 26 is defined by a wall 28 of a pipe 30. More particularly, an inner surface 32 of the wall 28 defines the fuel line path 26. The fuel 22 flows through the fuel line path 26 in a predominant direction 34 that may also be referred to as an axial direction of the fuel line path 26. At least one volume 36 is located proximate the wall 28 of the fuel line path 26. In an exemplary embodiment, the at least one volume 36 is a cavity formed within the wall 28. It is contemplated that a hole extending through the entire length of the wall 28 is present to fluidly couple the fuel line path 26 to the at least one volume 36, which may be externally located relative to the pipe 30. In the illustrated embodiment, the at least one volume 36 is merely a recess or cavity formed in the wall 28. In one embodiment, an orifice 38 may be present at the inner surface 32 of the wall 28 to fluidly couple the fuel line path 26 with the at least one volume 36 (FIGS. 4 and 5).

Irrespective of the precise location of the at least one volume 36 and the manner in which the at least one volume is fluidly coupled to the fuel line path 26, a flow manipulation member 40 is at least partially located within the at least one volume 36 to manipulate the mass flow pressure of the fuel 22 being routed through the fuel line path 26. The flow manipulation member 40 is fixed within the at least one volume 36. For example, the flow manipulation member 40 may be secured to one or more walls 42 of the at least one volume. The at least one volume 36 may be formed of various contemplated geometric shapes and the flow manipulation member 40 typically corresponds to the geometric cross-section of the at least one volume 36.

The flow manipulation member 40 is a piezoelectric member that is at least partially formed of piezoelectric material. The piezoelectric material is any suitable material that is configured to accumulate an electrical charge in response to applied mechanical stress and vice versa, where an internal generation of a mechanical strain results from an applied electrical field. The flow manipulation member 40 (i.e., piezoelectric member) may be any structure suitable to oscillate in a manner that imposes a mass flow pressure fluctuation on the immediately surrounding fuel flow region and therefore the overall fuel line path 26. Examples of piezoelectric members that may be employed include a plate, membrane, or diaphragm, but the preceding list is merely illustrative and not intended to be exhaustive.

The flow manipulation member 40 may be oriented in any manner within the at least one volume 36. In other words, the flow manipulation member 40 can be disposed in any angular orientation relative to the predominant direction 34 of the flow of the fuel 22 within the fuel line path 26. In one embodiment, the flow manipulation member 40 can be oriented in a substantially parallel direction as the predominant direction 34, as shown in FIGS. 2 and 5. In an alternative embodiment, the flow manipulation member 40 can be oriented in a substantially perpendicular direction as the predominant direction 34, as shown in FIG. 4.

In operation, the flow manipulation member 40 is configured to oscillate between two extreme conditions in response to an electrical charge generated within the piezoelectric member. During oscillation, a jet 44 of fuel flow is generated upon expulsion from the at least one volume 36 and introduced into the main flow of the fuel 22 within the fuel line path 26, as shown in FIGS. 4 and 5. As shown in FIG. 4, a plurality of flow manipulation members (i.e., piezoelectric members) may be included within the at least one volume 36 to facilitate mass flow pressure oscillation within the fuel line path 26. Furthermore, a plurality of volumes may be included along the wall of the fuel line path 26. In the illustrated embodiment, a first volume 46 and a second volume 48 are included, with each including a piezoelectric member. It is to be appreciated that any number of volumes may be included and may be axially spaced from each other along the fuel line path 26 and/or may be located within a single axial plane of the fuel line path 26 in a circumferentially spaced manner.

A controller may be included to be in communication with the flow manipulation member 40 in order to adjust one or more parameters of the flow manipulation member. In particular, a voltage applied to the piezoelectric material may be controlled to adjust the operation characteristics of the flow manipulation member 40. Examples of parameters that may be adjusted include the amplitude and driving frequency. Tuning of such parameters allows flexibility based on monitored operating conditions that may vary from application to application.

The flow manipulation member 40 may be configured to interact directly with the fuel 22 to impose a force on the overall fuel flow in a radially inward direction during the portion of oscillation of the flow manipulation member 40 in the radially inward direction. Alternatively, the flow manipulation member 40 may be operatively coupled to a valve or other flow regulating device to cyclically oscillate the valve between an open and a closed condition. The valve may be located within the at least one volume 36 and/or directly within the fuel line path 26. Cycling of the valve between the open and closed position facilitates mass flow pressure oscillation in a desirable manner.

Advantageously, oscillation of the mass flow provides flexibility to design for higher power requirements without being concerned about frequency and/or phase matching.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel supply system comprising:
a fuel line path configured to route a fuel to a combustion inlet region; and
a flow manipulation member disposed proximate the fuel line path, the flow manipulation member comprising a piezoelectric material configured to cyclically manipulate a mass flow pressure of the fuel being routed through the fuel line path.

2. The fuel supply system of claim 1, wherein the fuel line path is defined by an inner surface of a wall of a pipe.

3. The fuel supply system of claim 2, further comprising a volume disposed proximate the wall of the pipe and fluidly coupled to the fuel line path, wherein the flow manipulation member is located within the volume.

4. The fuel supply system of claim 3, wherein the volume comprises a cavity formed within the wall of the pipe.

5. The fuel supply system of claim 3, further comprising a plurality of flow manipulation members disposed within the volume.

6. The fuel supply system of claim 3, further comprising:
a plurality of flow manipulation members; and
a plurality of volumes axially spaced from each other and disposed proximate the wall of the pipe, each of the plurality of volumes fluidly coupled to the fuel line path and containing at least one of the plurality of flow manipulation members therein.

7. The fuel supply system of claim 3, wherein the flow manipulation member comprises a piezoelectric diaphragm.

8. The fuel supply system of claim 7, wherein the piezoelectric diaphragm is disposed within the volume and oriented substantially parallel to a predominant direction of flow of the fuel.

9. The fuel supply system of claim 7, wherein the piezoelectric diaphragm is disposed within the volume and oriented substantially perpendicular to a predominant direction of flow of the fuel.

10. The fuel supply system of claim 3, wherein the volume is fluidly coupled to the fuel line path via an orifice.

11. The fuel supply system of claim 1, further comprising a controller configured to adjust at least one parameter of the flow manipulation member upon controlling a voltage applied through the piezoelectric material.

12. A fuel supply system comprising:
a fuel line path configured to route a fuel to a combustion inlet region;
a valve located proximate the fuel line path; and
a piezoelectric member operatively coupled to the valve and configured to cycle the valve between an open condition and a closed condition to cyclically manipulate a mass flow pressure of the fuel being routed through the fuel line path.

13. The fuel supply system of claim 12, wherein the fuel line path is defined by an inner surface of a wall of a pipe.

14. The fuel supply system of claim 13, further comprising a volume disposed proximate the wall of the pipe and fluidly coupled to the fuel line path, wherein the piezoelectric member is located within the volume.

15. The fuel supply system of claim 14, wherein the volume comprises a cavity formed within the wall of the pipe.

16. The fuel supply system of claim 13, further comprising:
a plurality of piezoelectric members; and
a plurality of volumes axially spaced from each other and disposed proximate the wall of the pipe, each of the plurality of volumes fluidly coupled to the fuel line path and containing at least one of the plurality of piezoelectric members therein.

17. The fuel supply system of claim 13, wherein the piezoelectric member comprises a piezoelectric diaphragm.

18. The fuel supply system of claim 14, wherein the volume is fluidly coupled to the fuel line path via an orifice.

19. The fuel supply system of claim 12, wherein the fuel comprises a gas fuel.

20. A gas turbine system comprising:
a compressor;
a combustion assembly having at least one combustion chamber;
a turbine section; and
a fuel supply system configured to route a fuel to the combustion assembly, the fuel supply system comprising:
a fuel line path defined by an inner surface of a wall of a pipe, the fuel line path configured to route a fuel to a combustion inlet region;
a volume formed as a cavity in the wall of the pipe and fluidly coupled to the fuel line path via an orifice; and
a flow manipulation member located within the volume and configured to cyclically manipulate a mass flow pressure of the fuel being routed through the fuel line path, wherein the flow manipulation member comprises a piezoelectric material.
